(19) United States
(12) Patent Application Publication
(10) Pub. No.: US 2025/0181795 A1
(43) Pub. Date: Jun. 5, 2025

(54) METHOD FOR DESIGNING OR CONFIGURING A PROCESS, TECHNICALLY FUNCTIONAL GUI, SYSTEM COMPRISING A PROCESSOR UNIT, AND COMPUTER PROGRAM PRODUCT

(71) Applicant: FRAUNHOFER-GESELLSCHAFT ZUR FOERDERUNG DER ANGEWANDTEN FORSCHUNG E.V., Muenchen (DE)

(72) Inventors: Michael BORTZ, Kaiserslautern (DE); Karl-Heinz KUEFER, Weilerbach (DE); Raoul HEESE, Kaiserslautern (DE); Martin VON KURNATOWSKI, Kaiserslautern (DE)

(21) Appl. No.: 18/563,598

(22) PCT Filed: May 29, 2022
(86) PCT No.: PCT/IB2022/055043

§ 371 Date: Mar. 14, 2025

(30) Foreign Application Priority Data
May 29, 2021 (DE) 10 2021 113 938.4

(51) Int. Cl. G06F 30/20; G06F 30/12; G06F 111/06

(52) U.S. Cl. CPC G06F 30/20; G06F 30/12; G06F 2111/06

(57) ABSTRACT

Multi-criteria optimization of a process, such as a chemical or engineering process, is to be enabled or improved. Interaction between a user and an optimization tool is to be improved as well. A procedure for designing or devising a process is proposed to achieve this. The procedure has the steps of providing a value of a first design variable (x1, x2, . . . , xD) of the process; providing a value of a first parameter (y1, y2, . . . , yK) and a value of a second parameter (y1, y2, . . . ,yK), whereby the values of the parameters (y1, y2, . . . , yK) are formed based on the value of the first design variable (x1, x2, . . . , xD); providing a Pareto frontier (10) for the two parameters (y1, y2, . . . , yK); and determining a deviation of the value of the first parameter (y1, y2, . . . , yK) to a point (11, 12, . . . , 16) of the Pareto frontier (10) and/or determining a deviation of the value of the second parameter (y1, y2, . . . , yK) to the point (11, 12, . . . , 16) of the Pareto frontier (10).

The invention involves a procedure for designing or devising a process, in particular an engineering or chemical process, specifically by using multi-criteria optimization. The invention also involves an interactive graphical user interface (GUI) for multi-criteria optimization of a process.

Conflicting requirements often need to be reconciled when planning chemical or process engineering processes. In product development, for example, a composition with both a high degree of hardness and high elasticity may be required. Hard components are often relatively inelastic, and elastic components are often relatively soft. The proportions of a hard component and an elastic component can be varied in order to provide a composition with acceptable hardness and elasticity, whereby the improvement of one property (e.g. hardness of the composition) generally causes a deterioration of another property (e.g. elasticity of the composition). A compromise of the required properties can be achieved through multi-criteria optimization.

In the field of chemical synthesis, for example, there may be a trade-off between the degree of purity and the availability of a reactant. Reactants with a relatively high degree of purity may not be available for several months, while similar reactants with a lower degree of purity may be available immediately. Several reactants of the same type may be available, with the reactants possibly differing in their degree of purity and the readiness of their availability. Multi-criteria optimization allows the properties of the reactants to be weighed against one another.

A material separation process (e.g., rectification) with a high degree of purity of the separated components and low energy consumption may also be required. Frequently, a high degree of purity of a component separated from a mixture can only be attained by using a high amount of energy.

Multi-criteria optimization is not trivial, especially if there are a large number of possibilities—for example, if there are a large number of possible components in the product development process referred to above. The planning of such a process can overwhelm a user who is designing or devising (planning) the process.

Multi-criteria optimization is particularly challenging in the process design and operation of production plants. It is often the case that the best solution cannot be clearly defined or cannot be implemented, as retrofitting equipment is only possible at great expense.

US 2013 0088729 A1 (Fu-Xerox) uses a Pareto frontier in a copying machine with the target direction of color adjustment of a spot using a mapping of a target point (from an N-dimensional space) to the Pareto frontier.

US 2015 0227848 A1 (Amid-Int. Business Machines) deals with a multi-criteria problem approach, albeit with an abstract “decision-making tool”. This is about weighting and ranking.

Neither source has nothing to do with a chemical or procedural process. They can therefore only be weighted as general technical background A.

The technical task of the invention is to provide a procedure by which a multi-criteria optimization of a process, e.g., a chemical or procedural process, is enabled or improved. Interaction between a user and an optimization tool is to be improved as well.

A (first) procedure for designing or devising a process includes the following steps:
Providing a value of a first design variable of the process;
Providing a value of a first parameter and a value of a second parameter, whereby the values of the parameters are formed on the basis of the value of the first design variable;
Providing a Pareto frontier for the two parameters;
Determining a deviation of the value of the first parameter from a point of the Pareto frontier and/or determining a deviation of the value of the second parameter from the point of the Pareto frontier; see claim 1

Preferably, the procedure is used for designing or devising a procedural or chemical process.

For example, the process can be a production process, a synthesis process, a separation process, a mixing process, a rectification process or a drying process.

A design variable of the process can be a physical, chemical or procedural variable. For example, the design variable is a temperature, a pressure, a degree of purity of a substance, a substance or mass flow, a heat flow, a reflux ratio in a rectification column, a height of a rectification column or a division ratio in a divider. The process can be at least partially defined by the design variable. Multiple, in particular at least two, preferably at least three, more preferably at least five, most preferably at least ten, design variables can be provided.

A parameter (also known as a performance indicator) of the process can be a variable that characterizes the result of the process. For example, a parameter can be a throughput of a process, a degree of purity of a product of a process, an energy consumption level of a process, a reactant consumption level of a process, an equipment expense of a process, a duration of the process or an earliest start time of a process. In general, the quality of the process can be determined by a parameter. Multiple, in particular at least three, preferably at least four, more preferably at least five, parameters can be provided.

One or more parameters can be determined on the basis of the at least one design variable. This can be done by means of a calculation, for example. There may be a mathematical, physical and/or chemical relationship between the at least one design variable and the parameters.

A Pareto frontier is provided for the two parameters. The Pareto frontier can be determined within the process, or the Pareto frontier can be selected from a large number of Pareto frontiers that have already been determined.

A Pareto frontier (also a Pareto set) is the set of all Pareto optima. Various parameters (criteria) can often be defined for a process. For example, if a component is to be separated from a substance mixture, one parameter for the separation process can be the purity of the separated component and another parameter can be the energy consumption level of the process. Optimization of the parameters is often contradictory, i.e., a high degree of purity of the separated component can only be achieved with a high energy input, and a low energy consumption level can only be achieved with a low purity of the separated component. Optimization of such a process is a multi-criteria optimization (also called Pareto optimization).

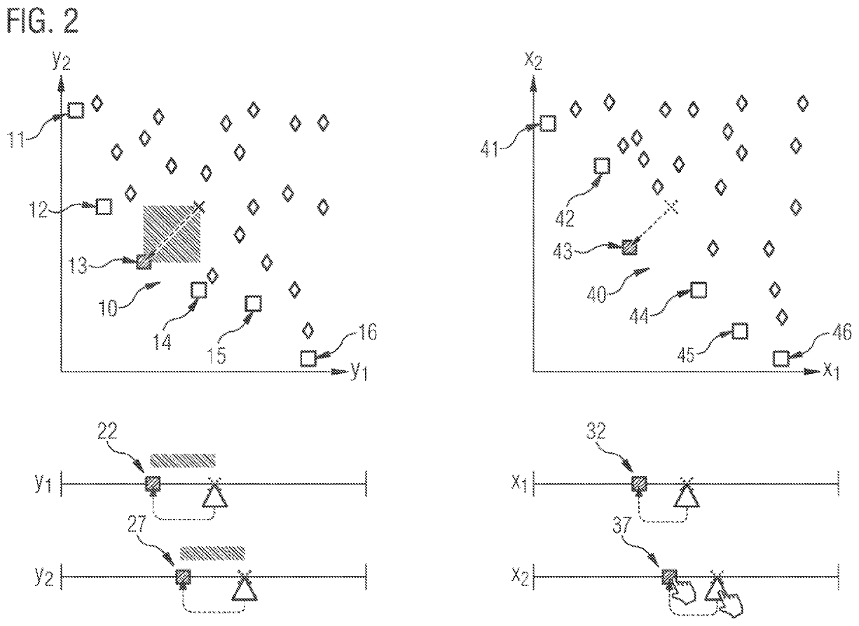

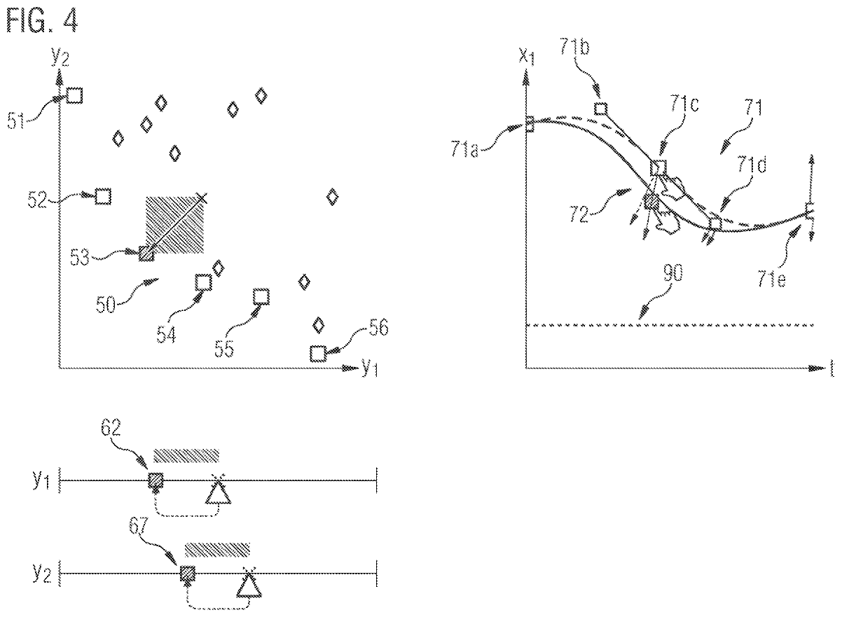

The following should be noted for an understanding of the Pareto frontier. A Pareto frontier is a function that is only functionally connected. A Pareto frontier has a large number of grid points. The frontier must therefore not be understood as continuous but as “functionally connected”, which is why grid points are shown in FIGS. 2 and 4. A line, such as one determined by interpolation, can be added between the grid points. The Pareto frontier can also be a projection from n-dimensional space, in which space it exists, but can only be represented graphically as a projection.

The Figures serve as examples to assist with the understanding of the general statements.

Accessible points on a multidimensional Pareto frontier can be visualized differently. Reachable points can be shown in light or contrasting colors. Points that cannot be reached, such as a projected surface, can have a different contrast or a different color.

A deviation of the value of the first parameter from a point on the Pareto frontier for the two parameters can be determined. Alternatively or additionally, a deviation of the value of the first parameter from the point of the Pareto frontier can be determined. A point on the Pareto frontier can be a grid point of the Pareto frontier.

This makes it possible to determine how large the key figures' deviation from a Pareto optimum for the key figures is. In other words, it is possible to determine how much optimization potential the process has based on the value of at least one design variable. The values of the key figures can be influenced by defining or changing at least one design variable. By defining or changing at least one design variable, the optimization potential can be exploited (at least partially or to the best possible extent).

Values of the first design variable of the process can be specified in the procedure. At least two of the values can differ from one another as a function of time. The values of the first design variable can include the value of the first design variable.

The point of the Pareto frontier for the two parameters can be determined or selected by a user. The Pareto frontier can include at least three, preferably at least five, more preferably at least ten points that can be selected by the user. The user can select or define one or more of these points.

The point can be selected or defined by the user by interacting with a display device. The display device can be a display or a touchscreen. Multiple points on the Pareto frontier can be shown on the display device, and the user can select one or more of the points, such as by a mouse click or by touch. The user can enter a value in a field on the display device, such as by using a keyboard, in order to select or determine one or more points on the Pareto frontier. A selection for points on the Pareto frontier can be shown on the display device. The user can select or define one or more points of the Pareto frontier from this selection.

The user can determine or change the value of the first design variable. The value of the design variable can be increased or decreased. For example, the design variable is the temperature of a process. The value of the design variable can be 130° C. The user can reduce the temperature value to 120° C. or increase it to 140° C. The user can also specify a value for the design variable. For example, it may be that no value is specified for the design variable and a user specifies the value for the first time. The value of the design variable can be defined or changed using an input field on a display device. The value of the design variable can also be defined or changed by manipulating an operating aid on the display device. The operating aid can be a slider or rotary control.

A value can be provided for the first design variable, and a value can be provided for a second design variable. The first design variable and the second design variable can be different design variables, in particular different physical, chemical or procedural variables.

As with the value of the first design variable, the user can also define or change the value of the second design variable. The value of the second design variable can be increased or decreased. For example, the second design variable is the pressure of a process. The value of the second design variable can be 3.0 bar. The user can reduce the pressure value to 2.5 bar or increase it to 3.5 bar. The user can also specify a value for the second design variable. For example, it may be that no value is specified for the second design variable and a user specifies the value for the first time. The value of the second design variable can be defined or changed using an input field on a display device. The value of the second design variable can also be defined or changed by manipulating an operating aid on the display device. The operating aid can be a slider or rotary control.

Values of the second design variable of the process can be specified in the procedure. At least two of the values can differ from one another as a function of time. The values of the second design variable can include the value of the second design variable.

The value of the first design variable can be defined or changed while the value of the second design variable remains unchanged. Likewise, the value of the second design variable can be defined or changed while the value of the first design variable remains unchanged. It is possible for the value of the first design variable to be defined or changed and the value of the second design variable to be defined or changed.

A Pareto frontier can be provided for the two design variables (first design variable and second design variable). Alternatively, a representation of the Pareto frontier can be provided for the two design variables.

The Pareto frontier for the two design variables can be determined within the procedure, or the Pareto frontier for the two design variables can be selected from a large number of Pareto fronts already determined for the two design variables. Likewise, the representation of the Pareto frontier for the two design variables can be determined within the procedure, or the representation of the Pareto frontier for the two design variables can be selected from a large number of already determined representations of Pareto fronts for the two design variables.

A Pareto frontier for the two design variables can be or have been determined on the basis of the Pareto frontier for the two parameters. The Pareto frontier for the two design variables can be based on the Pareto frontier for the two parameters. A representation of the Pareto frontier for the two design variables can be or have been determined on the basis of the Pareto frontier for the two parameters. The representation of the Pareto frontier for the two design variables can be based on the Pareto frontier for the two parameters.

A deviation of the value of the first design variable from a point on the Pareto frontier for the two design variables or from a point on the representation of the Pareto frontier for the two design variables can be determined. Alternatively or additionally, a deviation of the value of the second design variable from the point of the Pareto frontier for the two design variables or from the point of the representation of the Pareto frontier for the two design variables can be determined.

The point of the Pareto frontier for the two design variables or the point of the representation of the Pareto frontier for the two design variables can be defined or selected by a user. The Pareto frontier for the two design variables or the representation of the Pareto frontier for the two design variables can include at least three, preferably at least five, more preferably at least ten points, which can be selected by the user. The user can select or define one or more of these points.

The point of the Pareto frontier for the two design variables or the point of the representation of the Pareto frontier for the two design variables can be specified on the basis of the point of the Pareto frontier for the two parameters. The point of the Pareto frontier for the two design variables or the point of the representation of the Pareto frontier for the two design variables can be based on the point of the Pareto frontier for the two parameters.

In particular, the Pareto frontier for the two design variables or the representation of the Pareto frontier for the two design variables can be used to determine how the values of the design variables can be changed in order to specify the process in the direction of a Pareto optimum.

It can be determined whether the deviation of the value of the first design variable from the point of the Pareto frontier for the two design variables is reduced by increasing or decreasing the value of the first design variable. It can also be determined whether the deviation of the value of the first design variable from the point of the representation of the Pareto frontier for the two design variables is reduced by increasing or decreasing the value of the first design variable.

Alternatively or additionally, it can be determined whether the deviation of the value of the second design variable from the point of the Pareto frontier for the two design variables is reduced by increasing or decreasing the value of the second design variable. It can also be determined whether the deviation of the value of the second design variable from the point of the representation of the Pareto frontier for the two design variables is reduced by increasing or decreasing the value of the second design variable.

In other words, it can be determined how the value of the first design variable and/or the value of the second design variable needs to be changed in order to reduce a deviation from a Pareto optimum.

The value of the first design variable can be changed, such as by a user. The value of the second design variable can be changed, such as by a user. In particular, the value of the first and/or second design variable can be increased or decreased.

Preferably, the value of the first design variable can be changed in such a way that a deviation of the value of the first parameter from the point of the Pareto frontier for the two parameters is reduced.

The value of the first design variable can be changed in such a way that the deviation of the value of the first parameter from the point of the Pareto frontier for the two parameters is reduced and/or the deviation of the value of the second parameter from the point of the Pareto frontier for the two parameters is reduced. Alternatively or additionally, the value of the second design variable can be changed in such a way that the deviation of the value of the first parameter from the point of the Pareto frontier for the two parameters is reduced and/or the deviation of the value of the second parameter from the point of the Pareto frontier for the two parameters is reduced.

Preferably, the value of the first design variable and/or the value of the second design variable is changed by a user.

This allows the process to develop in the direction of a Pareto optimum. It bears mentioning that a process design representing a Pareto optimum is preferred, but in practice this may not always be feasible because, for example, existing systems cannot be completely replaced or converted without considerable expense. Even a process design that shows a relatively small deviation from a Pareto optimum (but at least less than before a change) can represent a significant technical improvement.

A (second) procedure for designing a process with interactive navigation includes the following steps:
Providing a value of a first design variable of the process;
Providing a value of a first parameter and a value of a second parameter (for the process), whereby the values of the two parameters (first and second parameter) are formed on the basis of the value of the first design variable
Providing a Pareto frontier for the two parameters;
Showing a first operating aid with a first selector for the value of the first design variable, whereby a setting or position of the selector represents the value of the design variable;
Showing a representation of the Pareto frontier for the two parameters on the first operating aid;
Moving or changing—through a user—the setting of the first selector of the first operating aid in the direction of the representation of the Pareto frontier for the two parameters; see claim 11.

The process is preferably a process procedural or chemical process.

The operating aid with the selector and/or the representation of the Pareto frontier for the two parameters can be displayed on a display device.

The operating aid can enable the user to change the value of the design variable. The operating aid can also communicate the (current) value of the design variable to the user. For example, the operating aid can include a bar with a slider as a selector. The value of the design variable can be changed by changing the position of the slider on the bar. By moving the slider on the bar in one direction, the value of the first design variable can be increased, and by moving the slider on the bar in another direction, such as in the opposite direction, the value of the second design variable can be reduced.

The operating aid can be designed in such a way that a rotary position of the operating aid conveys the (current) value of the design variable to the user. The value of the design variable can be changed by changing the rotary position of the operating aid. For example, the value of the design variable can be increased by a rotational change of the operating aid or a selector of the operating aid in one direction, and the value of the design variable can be reduced by a rotational change of the operating aid or the selector of the operating aid in another direction, particularly in an opposite direction.

In general, a variety of different operating aids allowing the user to change the value of the design variable are possible.

A representation of the Pareto frontier for the two parameters shown on the operating aid can be a marking on the operating aid that is based on the Pareto frontier for the two parameters or is formed on the basis of the Pareto frontier for the two parameters.

The representation of the Pareto frontier for the two parameters on the operating aid can convey to the user whether the value of the design variable needs to be increased or decreased in order to change the process in the direction of a Pareto optimum.

A value for a first design variable and a value for a second design variable can be provided.

The first operating aid with the first selector can be shown for the value of the first design variable. The setting or position of the first selector can represent the value of the first design variable. A second operating aid with a second selector can be shown for the value of the second design variable. The setting or position of the second selector can represent the value of the second design variable. A representation of the Pareto frontier for the two parameters (first and second parameter) can respectively be shown on the first and second operating aids. A representation of the Pareto frontier for the two parameters can be shown on the first operating aid, and a representation of the Pareto frontier for the two parameters can be shown on the second operating aid.

The user can move or change the setting or position of the first selector in the direction of the representation of the Pareto frontier for the two parameters. Alternatively or additionally, the user can move or change the setting or position of the second selector in the direction of the representation of the Pareto frontier for the two parameters. This can reduce a deviation between at least one of the parameters and the point of the Pareto frontier for the two parameters.

Preferably, the setting or position of the first selector is moved or changed in the direction of the representation of the Pareto frontier for the two parameters by an input from the user. Alternatively or additionally, the setting or position of the second selector can be moved or changed in the direction of the representation of the Pareto frontier for the two parameters by an input from the user.

The user's input can be made on a display device on which the operating aid is shown or on which the operating aids are shown. The user's input can also be made on a device that is physically or non-physically connected to the display device. The input can be made by the user touching the display device. Alternatively, the input can be made using an input device such as a mouse or keyboard.

A first operating aid with a first selector can be shown for the value of the first parameter. A setting or position of the first selector can represent the value of the first parameter. A second operating aid with a second selector can be shown for the value of the second parameter. A setting or position of the second selector can represent the value of the second parameter.

The first operating aid with the first selector for the value of the first parameter can have the same or similar design and function as the first operating aid with the first selector for the value of the first design variable. The second operating aid with the second selector for the value of the second parameter can have the same or similar design and function as the second operating aid with the second selector for the value of the second design variable.

A representation of the Pareto frontier for the two parameters is or can be shown on the first operating aid for the value of the first parameter. A representation of the Pareto frontier for the two parameters is or can be shown on the second operating aid for the value of the second parameter.

The user can move or change the setting or position of the first selector for the value of the first parameter in the direction of the representation of the Pareto frontier for the two parameters. The user can move or change the setting or position of the second selector for the value of the second parameter in the direction of the representation of the Pareto frontier for the two parameters.

The setting or position of the first selector for the value of the first parameter and/or the setting or position of the second selector for the value of the second parameter can be changed by an input from the user, in particular as described above.

An operating aid can be shown with a selector for at least a first design variable. Preferably, an operating aid with a selector is shown for a first design variable and for a second design variable. An operating aid with a selector can be shown for at least a first parameter. Preferably, an operating aid with a selector is shown for a first parameter and for a second parameter. A representation of the Pareto frontier for the two parameters can be shown on each of the operating aids.

Disclosed is an interactive graphical user interface (GUI), in particular as a technically functional GUI, for designing or devising a process. The process can be a procedural or chemical process. A Pareto frontier is formed for a first parameter and a second parameter. Values of the parameters are formed on the basis of a value of a first design variable of the process. An initial operating aid with an initial selector for the value of the first design variable is shown. A setting or position of the first selector represents the value of the first design variable. A representation of the Pareto frontier for the parameters is shown on the first operating aid for the first design variable.

As described above, the representation of the Pareto frontier for the parameters can be a marker on the operating aid.

The first selector for the value of the first design variable can be actuated by a user so that the value of the first design variable is changed. The first selector for the value of the first design variable can be actuated by a user in the direction of the representation of the Pareto frontier for the parameters.

The user can therefore enter or manipulate data via the GUI. The representation of the Pareto frontier for the parameters supports the user in the selection of the data entered. In other words, by representing the Pareto frontier for the parameters, the user can see in which direction the value of the first design variable needs to be changed in order to develop or devise the process in the direction of a Pareto optimum.

The values of the parameters (first parameter and second parameter) can be formed on the basis of the value of the first design variable of the process and a second value of a second design variable of the process.

A second operating aid with a second selector can be shown for the value of the second design variable. A setting or position of the second selector can represent the value of the second design variable. A representation of the Pareto frontier for the parameters can be shown on the second operating aid for the second design variable.

The selector for the value of the second design variable can be actuated by a user so that the value of the second design variable is changed. The selector for the value of the second design variable can be actuated by a user in the direction of the representation of the Pareto frontier for the parameters.

A first operating aid with a first selector can be shown for the value of the first parameter. A setting or position of the first selector can represent the value of the first parameter. A representation of the Pareto frontier for the parameters can be shown on the first operating aid for the first parameter. The first selector can be actuated by a user.

A second operating aid with a second selector can be shown for the value of the second parameter. A setting or position of the second selector can represent the value of the second parameter. A representation of the Pareto frontier for the parameters can be displayed on the second operating aid for the second parameter. The selector can be operated by a user.

The Pareto frontier or a representation of the Pareto frontier can be displayed. A point on the Pareto frontier or a point on the representation of the Pareto frontier can be selected by a user. The representation can be formed on the respective operating aid based on the point of the Pareto frontier.

In general, the GUI can be displayed on a display device. The display device can be a display or a touchscreen. The user can communicate with the GUI via the display device, for example to enter or change a value, or the user can communicate with the GUI via a device that communicates with the display device.

A (third) procedure for designing or devising a process includes the following steps:
Providing values of a design variable of the process, whereby at least two of the values differ from one another as a function of time;
Providing a value of a first parameter and a value of a second parameter, whereby the values of the parameters are formed on the basis of the values of the first design variable;
Providing a Pareto frontier for the two parameters; and determining a deviation of the value of the first parameter from the Pareto frontier and/or determining a deviation of the value of the second parameter from the Pareto frontier; see claim 28

The process is preferably devised as a procedural process or as a chemical process.

Values of design variables can be defined as a function of time. In a batch process, for example, a design variable can take on different values at different times. Such a process can include a start-up period in which, for example, the temperature in a reactor is increased. Even so, other design variables can have different values at different times. Particularly in the case of the production of speciality chemicals or speciality pharmaceuticals, it is regularly the case that only smaller quantities are manufactured in a production process. The process can be an unsteady or transient process.

At least five, preferably at least ten, more preferably at least 25, most preferably at least 50, values can be provided for the first design variable. At least two, preferably at least 20% or at least 50%, of the values can differ from one another as a function of time.

The values can be defined by a mathematical function.

In the procedure, a deviation of the value of the first parameter from a point on the Pareto frontier can be determined. Alternatively or additionally, a deviation of the value of the second parameter from the point of the Pareto frontier can be determined.

At least one of the design variable values can be determined or changed by a user.

A trajectory for the design variable can be determined on the basis of the Pareto frontier for the two parameters. Values of at least two points on the trajectory can be different from one another as a function of time.

The curvature of a curve through the values of the design variable can be changed. Preferably, the curvature of the curve is changed by a user using the values of the design variable.

At least values for the first design variable can be provided, and values for at least one second design variable can be provided. At least two of the values for the first design variable can differ from one another as a function of time, and at least two of the values for the second design variable can differ from one another as a function of time.

The procedure may be similar or identical to any procedure disclosed there. In particular, the procedure may include any procedure step disclosed there.

A (fourth) procedure for designing a process with interactive navigation includes the following steps:
Providing values of a design variable of the process;
Providing a value of a first parameter and a value of a second parameter, whereby the values of the parameters are formed on the basis of the values of the design variable;
Providing a Pareto frontier for the two parameters (first parameter and second parameter);
Showing an operating aid with at least two selectors for the values of the design variable, whereby a setting or position of the selectors define or reflect the values of the design variable;
Showing a representation of the Pareto frontier for the two parameters and moving or changing—through a user—the setting of at least one of the selectors of the operating aid.

At least two of the values of the first design variable can differ from one another as a function of time.

By moving or changing the setting of at least one of the selectors, the curvature of a curve can be changed by the values of the design variable.

The operating aid can include at least three, preferably at least four, more preferably at least five, selectors.

Disclosed is an interactive graphical user interface (GUI), in particular as a technically functional GUI, for designing or devising a process. The process can be a procedural or chemical process. A Pareto frontier is formed for a first parameter and a second parameter. Values of the parameters are formed on the basis of values of a design variable of the process. An initial operating aid with at least two selectors is shown for the values of the design variable. A setting or position of the selectors defines the values of the design variable or reflects the values of the design variable. A representation of the Pareto frontier for the parameters is shown.

A curve is formed by the values of the design variable. The curve can be shown,

The curvature of the curve can be changed by actuating at least one of the selectors. Actuation can be done by a user.

The representation of the Pareto frontier can be curved, bent or arched.

A (further) procedure for designing a process involves the following steps:
Providing a value of a first design variable of the process;
Providing a value of a first parameter, whereby the value of the first parameter is formed on the basis of the value of the first design variable;
Providing an optimized value for the first parameter;
Determining a deviation of the value of the first parameter from the optimized value for the first parameter; see claim 28

The process can be a procedural process or a chemical process.

The first parameter can be any parameter disclosed there. The optimized value for the first parameter can be a value that is optimized in relation to the first value of the first parameter. The optimized value can be understood as a mathematically optimized value. The optimized value can be a minimum or a maximum of a function, in particular a target function. The optimized value can be the result of a (mathematical) optimization.

For example, the first parameter can be the energy consumption level of a process. Energy consumption is to be optimized. The energy consumption level can be described by an target function, such as one with at least two parameters or variables. The optimized value is the minimum energy consumption level.

A user can specify or change the value of the first design variable.

A representation of the optimized value for the design variable can be provided. The representation of the optimized value can be based on the optimized value for the first parameter.

A deviation of the value of the first design variable from the representation of the optimized value can be determined.

It can be determined whether the deviation of the value of the first design variable from the representation of the optimized value is reduced by increasing or decreasing the value of the first design variable.

The value of the first design variable can be changed, in particular by a user. The value of the first design variable can be changed in such a way that the deviation of the value of the first parameter from the optimized value for the first parameter is reduced.

A value for the first design variable and a value for a second design variable can be provided. The value of the first parameter can be formed on the basis of the value of the first design variable and the second design variable.

A (still further) procedure for designing a process with interactive navigation includes the following steps:
Providing a value of a first design variable of the process;
Providing a value of a first parameter, whereby the value of the parameter is formed on the basis of the value of the design variable
Providing an optimized value for the first parameter;
Showing a first operating aid with a first selector for the value of the first design variable, whereby a setting or position of the selector represents the value of the design variable;
Showing a representation of the optimized value for the first parameter on the first operating aid;
Moving or changing—through a user—the position of the first selector of the first operating aid in the direction of the representation of the optimized value for the first parameter; see claim 33

The process is preferably a process procedural process or a chemical process.

A value for the first design variable and a value for a second design variable can be provided. In particular, a value for the first design variable and a value for the second design variable can be provided.

The first operating aid with the first selector can be shown for the value of the first design variable. The setting or position of the first selector can represent the value of the first design variable. A second operating aid with a second selector can be shown for the value of the second design variable. The setting or position of the selector can represent the value of the second design variable. A representation of the optimized value for the first parameter can respectively be shown on the first and second operating aids. A representation of the optimized value for the first parameter can be shown on the first operating aid. A representation of the optimized value for the second parameter can be shown on the second operating aid.

A first operating aid with a first selector can be shown for the value of the first parameter. A setting or position of the first selector can represent the value of the first parameter.

A representation of the optimized value for the first parameter can be shown for the value of the first parameter on the first operating aid.

The user can move or change the settings of the first selector in the direction of the representation of the optimized value for the first parameter.

Disclosed is an interactive graphical user interface (GUI), in particular as a technically functional GUI, for designing or devising a process. The process can be a procedural or chemical process. A value of a first design variable of the process and a value of a first parameter are provided. The value of the first parameter is formed on the basis of the value of the first design variable. An optimized value for the value of the first parameter is provided; a first operating aid with a first selector for the value of the first design variable is shown. A setting or position of the selector represents the value of the first design variable; and a representation of the optimized value for the value of the first parameter is shown on the first control aid for the first design variable.

The selector for the value of the first design variable can be actuated by a user so that the value of the first design variable is changed. The selector for the value of the first design variable can be actuated by a user in the direction of the representation of the Pareto frontier for the parameters.

The first value of the parameter can be formed on the basis of the value of the first design variable of the process and a second value of a second design variable of the process.

A second operating aid with a second selector can be shown for the value of the second design variable. A setting or position of the second selector can represent the value of the second design variable. A representation of the optimized value for the first parameter can be displayed on the second operating aid for the second design variable.

A first operating aid with a first selector can be shown for the value of the first parameter. A setting or position of the first selector can represent the value of the first parameter. A representation of the optimized value can be shown for the first parameter on the first operating aid for the first parameter. The first selector can be actuated by one or more users.

The GUI can be shown on a display device. The display device can be a display or a touchscreen.

A system can include a processor unit. The processor unit may be configured in such a way to perform a procedure disclosed there. The processor unit can be equipped to perform a procedure disclosed there. The processor unit can be configured in such a way to generate or provide a GUI disclosed there. The processor unit can may be arranged to generate or provide a GUI disclosed there.

The system may include a memory, in particular a non-volatile memory. The memory may include instructions to perform a procedure disclosed there. The memory may include instructions to generate or provide a GUI disclosed there.

A computer program product may include commands which, when performed (the program) by a computer, cause the computer to perform a procedure disclosed there. A computer program product may include commands which, when performed (the program) by a computer, cause the computer to generate or provide a GUI disclosed there.

Embodiment examples of the invention are explained in more detail with the aid of the Figures. All explanations are equally applicable to the disclosure, but they are not to be interpreted in such a way that they must be included as necessary elements of the claims. All of the following examples remain examples, even if they are not explicitly preceded by “for example”.

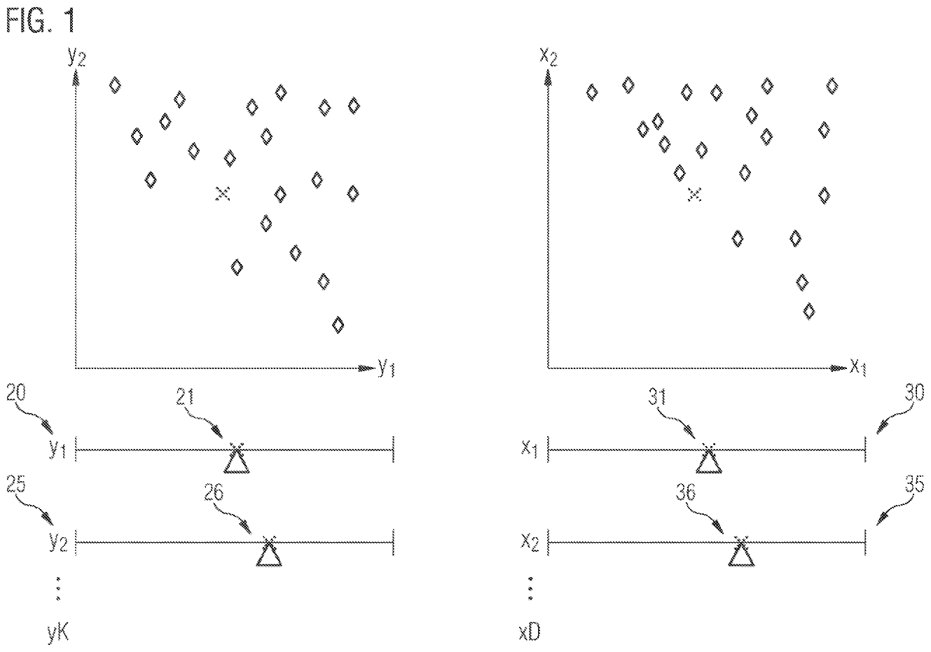

FIG. 1 illustrates the sequence of a procedure of one or more embodiments of the invention;

FIG. 2 illustrates the sequence of a procedure of one or more embodiments of the invention as shown in FIG. 1;

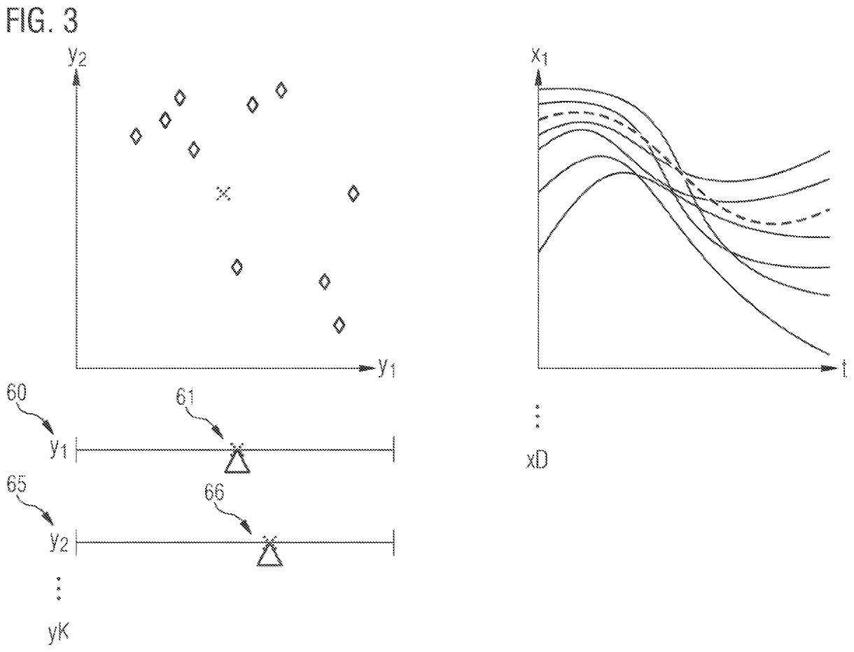

FIG. 3 illustrates the sequence of a procedure one or more embodiments of the invention; and

FIG. 4 illustrates the sequence of a procedure of one or more embodiments of the invention as shown in FIG. 3;

FIG. 1 on the right shows a relationship between a first design variable x1 and a second design variable x2. A point 105 in an x1-x2 diagram is yielded by a provided value for the first design variable x1 and a provided value for the second design variable x2.

As described at the beginning, it is sufficient if at least one design variable is considered and at least one value is provided for the design variable. Even so, multiple design variables, e.g., three, four, five or more than five design variables, can be considered. A value is or can be provided for each of the design variables. The relationship between multiple design variables can be visualized using a projection. Two design sizes are shown in the Figures purely as examples for better understanding.

Point 105 in the x1-x2 diagram represents a currently selected design of the process, with the first design variable x1 and the second design variable x2 considered. The real process can be defined by more than two design variables, whereby not all design variables of the process need to be changeable and represented in the procedure.

The value for the first design variable x1 and the value for the second design variable x2 can be entered by a user, e.g., via an input device or a display device. The value for the first design variable x1 and the value for the second design variable x2 can also be stored in a memory.

In addition to point 105, which is based on the current values of the first design variable x1 and the second design variable x2, pre-stored or already determined points 100 (shown as diamonds in FIG. 1 on the right) can be provided. Points 100 can be based on values of the first design variable x1 and the second design variable x2 that have been saved by a user. Points 100 can be orientation or grid points.

The x1-x2 diagram with point 105 can be shown on a display device. In addition, points 100 can be shown on the display device.

FIG. 1 shows a first operating aid 30 and a second operating aid 35 on the right. An operating aid can be provided for each design variable under consideration. If, for example, (exactly) one design variable is considered, (exactly) one operating aid can be provided. If, for example, n design variables xD are considered, n operating aids can be provided.

The first operating aid 30 can include a first selector 31. The second operating aid can include a second selector 36. The position or location of the first selector 31 can represent the value of the first design variable x1. The position or location of the second selector 36 can represent the value of the second design variable x2.

The positions or locations of the first selector 31 and the second selector 36 may correlate with point 105. In other words, the position of point 105 in the x1-x2 diagram and the positions or locations of the first selector 31 and the second selector 36 may be coupled together.

The operating aids for the design variables, in particular with the corresponding selector, can be shown on a display device.

FIG. 1 illustrates a relationship between a first parameter y1 and a second parameter y2 on the left. A point 115 in a y1-y2 diagram is defined by a value of the first parameter y1 and a value of the second parameter y2.

It is sufficient for at least one parameter to be considered. To this end, at least one value can be provided for the parameter. Multiple parameters, e.g., three, four, five or more than five parameters, can be considered. A value is or can be provided for each of the parameters. The relationship between multiple parameters can be visualized using a projection. Once again, two parameters are shown in the Figures purely as examples for better understanding.

The number of design variables considered can be independent of the number of parameters considered. Alternatively, the number of design variables considered can be the same as the number of parameters considered.

Point 115 represents a value of the first parameter y1 and a value of the second parameter y2. Point 115 can be provided—in particular, shown—in the y1-y2 diagram (left in FIG. 1).

The values of the first parameter y1 and the second parameter y2 can be based on the values of the first design variable x1 and the second design variable x2. The values of the first parameter y1 and the second parameter y2 can be formed on the basis of the values of the first design variable x1 and the second design variable x2.

A user can select the parameters to be considered. A user can also select design variables to be considered.

Additional points 110 may be provided. These points are shown as diamonds in FIG. 1 on the left. Points 110 can be pre-saved or already defined points. Each of the points 110 for the parameters can (respectively) be based on a point 100 for the design variables. Each of the points 110 for the parameters can (respectively) be formed on the basis of one of the points 100.

The y1-y2 diagram with point 115 can be shown on a display device. In addition, points 110 can be shown on the display device.

FIG. 1 on the left also shows a first operating aid 20 and a second operating aid 25 for the parameters. A (separate) operating aid can be provided for each parameter under consideration. When considering (exactly) one parameter, (exactly) one operating aid can be provided for the parameter. When considering n parameters yK, n operating aids can be provided for the parameters.

The first operating aid 20 for the first parameter y1 can include a first selector 21. The second operating aid 25 for the second parameter y2 can include a second selector 26. The position or location of the first selector 21 for the first parameter y1 can represent the value of the first parameter y1. The position or location of the second selector 26 for the second parameter y2 can represent the value of the second parameter y2.

The positions or locations of the first selector 21 for the first parameter y1 and of the second selector 26 for the second parameter y2 can correlate with point 115. The position of point 115 in the y1-y2 diagram and the positions or locations of the first selector 21 for the first parameter y1 and the second selector 26 for the second parameter y2 can be coupled to one another.

The operating aids for the parameters, in particular with the corresponding selector, can be shown on a display device.

For example, the process under consideration can be a separation of substances. The first parameter can, for example, be a heat flow, and the second parameter can be a degree of purity of a separated substance. The first design variable can be a temperature of the process, and the second design variable can be a pressure of the process. A user can provide a value for the temperature, e.g., 120° C., and a pressure, e.g., 3.5 bar (3,500 hPa). Values for the temperature and pressure can also be stored in the system, such as in a memory. Values for the heat flow (first parameter) and the degree of purity of the separated substance (second parameter) can be defined based on the values of the temperature (first design variable) and the pressure (second design variable). The values for the first parameter and the second parameter can be determined. The user can therefore directly see which value is yielded for the heat flow of the process and which value is yielded for the degree of purity of the separated substance based on the design variables, i.e., the temperature and pressure, for the process.

The representation in FIG. 2 refers to the representation in FIG. 1 and illustrates the role of the user in the process.

As shown in FIG. 2 on the left, a Pareto frontier 10 can be provided for the first parameter y1 and the second parameter y2. Pareto frontier 10 does not need to be understood as continuous but instead can be understood as functionally connected. For example, grid points 11, 12, 13, 14, 15, 16 of Pareto frontier 10 are or can be provided.

Each of the grid points 11, 12, 13, 14, 15, 16 can represent a Pareto optimum for the two parameters y1, y2.

A deviation can be determined between a point of Pareto frontier 10, such as a grid point 11, 12, 13, 14, 15, 16 of Pareto frontier 10, and point 115 of the two parameters y1, y2. The deviation can be understood as optimization potential.

The process can be designed in such a way that one of the two parameters or both parameters are improved without either of the two parameters worsening. For example, if a parameter is the purity of a separated substance, an improvement in this parameter would increase the purity, and a worsening in this parameter would reduce the purity.

A user can select a point on Pareto frontier 10. The point can be one or more of grid points 11, 12, 13, 14, 15, 16 of Pareto frontier 10. A user can select multiple points on Pareto frontier 10, such as at different times.

A Pareto frontier 40 can be provided for the first design variable x1 and the second design variable x2. Pareto frontier 40 for design variables x1, x2 can generally be a representation of Pareto frontier 40 for design variables x1, x2 or a representation of Pareto frontier 10 for two parameters y1, y2. For example, Pareto frontier 40 for design variables x1, x2 can be based on Pareto frontier 10 for parameters y1, y2. Pareto frontier 40 for design variables x1, x2 can also be formed on the basis of Pareto frontier 10 for parameters y1, y2.

Pareto frontier 40 for design variables x1, x2 does not need to be understood as continuous but instead can be understood as functionally connected. Grid points 41, 42, 43, 44, 45, 46 of Pareto frontier 40 are or can be provided. Each of grid points 41, 42, 43, 44, 45, 46 can represent a Pareto optimum for design variables x1, x2.

A deviation can be determined between a point of Pareto frontier 40, such as a grid point 41, 42, 43, 44, 45, 46 of Pareto frontier 40, and point 105 of the two design variables x1, x2. This deviation can be understood as an “path towards optimization”. For Pareto optimization of the process, one or more of the design variables can be changed according to the deviation.

A user can select a point on Pareto frontier 40, in particular one or more of grid points 41, 42, 43, 44, 45, 46 of Pareto frontier 40. It is also possible for the user to make multiple selections, such as at different times, from several points on Pareto frontier 40.

Points on Pareto frontier 10 for parameters y1, y2 and points on Pareto frontier 40 for design variables x1, x2 can be linked with one another. If, for example, a point is selected on Pareto frontier 10 for parameters y1, y2, a point linked to this point can (also) be selected on Pareto frontier 40 for design parameters x1, x2. If a point is selected on Pareto frontier 40 for design variables x1, x2, a point linked to this point can (also) be selected on Pareto frontier 10 for parameters y1, y2. The point can be selected by the user.

The first operating aid 30 for the first design variable x1 may include a first selector 31, as described above, for example. In addition to the first selector 31, a representation 32 of Pareto frontier 40 for design variables x1, x2 can be displayed on or in the first operating aid 30. Representation 32 of Pareto frontier 40 for design variables x1, x2 can be a marking on the first operating aid 30. Representation 32 can be a representation of a point of Pareto frontier 40 for design variables x1, x2. Preferably, representation 32 is a representation of the selected point of Pareto frontier 40 for design variables x1, x2.

A distance between representation 32 of Pareto frontier 40 for design variables x1, x2 and the first selector 31 of the first operating aid 30 can convey to the user the value by which the first design variable x1 would need to be changed in order to come closer to or reach a Pareto optimum of the process. Even so, the position or location of representation 32 of Pareto frontier 40 for design variables x1, x2 relative to the position or location of the first selector 31 of the first operating aid 30 can convey to the user in which direction the value of the first design variable x1 is to be changed, I.e. whether the value of the first design variable x1 must be increased or decreased in order to come closer to or reach a Pareto optimum of the process.

Similarly, a representation 37 of Pareto frontier 40 for the design variables can be provided on the second operating aid 35 for the second design variable x2. Representation 37 may be provided in addition to the second selector 36. Representation 37 can be a marker. Representation 37 of the second operating aid 35 may be similar or identical to representation 32 of the first operating aid 30.

In general, a representation of the Pareto frontier for the design variables can be provided for each operating aid for a design variable.

A first design variable x1 and a second design variable x2 are to be understood as examples. (Exactly) one design variable can be provided, or more than two design variables can be provided. A first parameter y1 and a second parameter y2 are also to be understood as examples. (Exactly) one parameter can be provided, or more than two parameters can be provided.

Pareto frontier 40, the first operating aid 30, in particular with representation 32 of Pareto frontier 40, and/or the second operating aid 35, in particular with representation 37 of Pareto frontier 40, can be shown on a display device.

A user can change the value of the first design variable x1. In particular, the user can change the value of the first design variable x1 in the direction of representation 32 on the first operating aid 30. The user can change the value of the first design variable x1 in such a way that a deviation between the value of the first design variable x1 and the point on Pareto frontier 40 for the design variables is reduced.

To this end, the user can move selector 31 in the direction of representation 32 of the first operating aid 30. For example, this can be done by marking selector 31 and dragging selector 31 to a different position.

Alternatively, the value of the first design variable x1 can be changed automatically. Preferably, the user can start a function that changes the value of the first design variable x1. For example, the user can press a button (not shown in the Figures), such as by selecting or clicking on “Improve”, which changes the value of the first design variable.

Similarly, the user can change the value of the second design variable x2. In particular, the user can change the value of the second design variable x2 in the direction of representation 37 on the second operating aid 35. The user can change the value of the second design variable x2 so that a deviation between the value of the second design variable x2 and the point on Pareto frontier 40 for the design variables is reduced. The change in the value of the second design variable x2 can be identical or similar to the change in the value of the first design variable x1, such as by the described movement of the selector in the direction of the representation or by the described automated change. Marking and moving the second selector 36 in the direction of representation 37 is indicated in FIG. 2 by a hand symbol 120.

The value of the first design variable x1 and the value of the second design variable x2 can be coupled to one another in such a way that a change in the value of the first design variable x1 causes a change in the value of the second design variable x2 and/or a change in the value of the second design variable x2 causes a change in the value of the first design variable x1. Alternatively, the values of the first design variable x1 and the second design variable x2 can be decoupled so that a change in the value of the first design variable x1 does not cause a change in the value of the second design variable x2 and/or so that a change in the value of the second design variable x2 does not cause a change in the value of the first design variable x1,

In particular, the first selector 31 of the first operating aid 30 and the second selector 36 of the second operating aid 35 can be coupled to one another in such a way that a movement of the first selector 31 causes a movement of the second selector 36 and/or a movement of the second selector 36 causes a movement of the first selector 31.

Alternatively, the first selector 31 of the first operating aid 30 and the second selector 36 of the second operating aid 35 can be decoupled, so that a movement of the first selector 31 does not cause a movement of the second selector 36 and/or so that a movement of the second selector 36 does not cause a movement of the first selector 31.

The first operating aid 20 for the first parameter y1 may include a first selector 21, as described above, for example. In addition to the first selector 21, a representation 22 of Pareto frontier 10 for parameters y1, y2 can be shown on or in the first operating aid 20. Representation 22 of Pareto frontier 10 for parameters y1, y2 can be a marking on the first operating aid 20. Representation 22 can be a representation of a point of Pareto frontier 10 for parameters y1, y2. Preferably, representation 22 is a representation of the selected point of Pareto frontier 10 for parameters y1, y2.

Similar to the first operating aid 30 for design variables x1, x2, representation 22 of the first operating aid 30 for parameters y1, y2 can convey to the user how a value of the first parameter y1 is to be changed in order to come closer to or reach a Pareto optimum of the process.

A representation 27 of Pareto frontier 10 for the parameters can be provided on the second operating aid 25 for the second parameter y2. Representation 27 may be provided in addition to the second selector 26. Representation 27 can be a marker. Representation 27 of the second operating aid 25 can be similar or identical to representation 22 of the first operating aid 20.

In general, a representation of the Pareto frontier for the parameters can be provided for each operating aid for a parameter. Here, too, a first parameter and a second parameter are merely examples.

Pareto frontier 10, the first operating aid 20, in particular with representation 22 of Pareto frontier 10, and/or the second operating aid 25, in particular with representation 27 of Pareto frontier 10, can be shown on a display device.

A user can change the value of the first parameter y1. In particular, the user can change the value of the first parameter y1 in the direction of representation 22 on the first operating aid 20. The user can change the value of the first parameter y1 in such a way that a deviation between the value of the first parameter y1 and the point on Pareto frontier 10 for the parameters is reduced.

To do this, the user can move selector 21 in the direction of representation 22 of the first operating aid 20. For example, this can be done by marking selector 21 and dragging selector 21 to a different position.

Alternatively, the value of the first parameter y1 can be changed automatically. Preferably, the user can start a function that changes the value of the first parameter y1. For example, the user can press a button (not shown in the Figures), such as by selecting or clicking on “Improve”, which changes the value of the first parameter.

The user can change the value of the second parameter y2. In particular, the user can change the value of the second parameter y2 in the direction of representation 27 on the second operating aid 25. The user can change the value of the second parameter y2 so that a deviation between the value of the second parameter y2 and the point on Pareto frontier 10 for the parameters is reduced. The change in the value of the second parameter y2 can be identical or similar to the change in the value of the first parameter y1, such as by moving the selector in the direction of the representation or by the automatic change.

The value of the first parameter y1 and the value of the second parameter y2 can be coupled to one another in such a way that a change in the value of the first parameter y1 causes a change in the value of the second parameter y2 and/or a change in the value of the second parameter y2 causes a change in the value of the first parameter y1. Alternatively, the values of the first parameter y1 and the second parameter y2 can be decoupled so that a change in the value of the first parameter y1 does not cause a change in the value of the second parameter y2 and/or so that a change in the value of the second parameter y2 does not cause a change in the value of the first parameter y1.

In particular, the first selector 21 of the first operating aid 20 and the second selector 26 of the second operating aid 25 can be coupled to one another in such a way that a movement of the first selector 21 causes a movement of the second selector 26 and/or a movement of the second selector 26 causes a movement of the first selector 21.

Alternatively, the first selector 21 of the first operating aid 20 and the second selector 26 of the second operating aid 25 can be decoupled so that a movement of the first selector 21 does not cause a movement of the second selector 26 and/or so that a movement of the second selector 26 does not cause a movement of the first selector 21.

The value of the first design variable x1 and the value of the first parameter y1 can be coupled to one another in such a way that a change in the value of the first design variable x1 causes a change in the value of the first parameter y1 and/or a change in the value of the first parameter y1 causes a change in the value of the first design variable x1. Alternatively, the value of the first design variable x1 and the value of the first parameter y1 can be decoupled.

All values of design variables and all values of parameters can be coupled with one another or decoupled.

Instead of a Pareto frontier—in particular a Pareto frontier 10 for the parameters—an optimized value can be provided. The optimized value can replace Pareto frontier 10 for the parameters. In particular, this can be provided if (exactly) one parameter is provided or is being considered.

FIG. 3 on the right shows the curve of a design variable x1 over time. In the example in FIG. 3 on the right, design variable x1 is plotted against time t (x1-t diagram).

Multiple curves are shown, whereby one curve 135 (dashed curve) is a currently selected curve of design variable x1. Further curves 130 are shown, whereby curves 130 are not currently selected.

Design variable x1 can be a temperature, for example. The value of the temperature can change depending on the time (of the process). This is specified particularly for batch processes. The curve can be formed by several values of design variable x1 as a function of time.

One design variable x1 is provided in FIG. 3; multiple design variables xD are possible.

The value for design variable x1 can be entered by a user, e.g., via an input device or a display device. The value for the first design variable x1 can also be stored in a memory.

The x1-t diagram with curve 135 can be shown on a display device. In addition, curves 130 can be shown on the display device.

FIG. 3 on the left illustrates a relationship between a first parameter y1 and a second parameter y2. A point 145 in a y1-y2 diagram is defined by a value of the first parameter y1 and a value of the second parameter y2. It is sufficient for at least one parameter to be considered. To this end, at least one value can be provided for the parameter.

The values of the first parameter y1 and the second parameter y2 can be based on the values of the first design variable x1. The values of the first parameter y1 and the second parameter y2 can be formed on the basis of the values of the first design variable x1.

Additional points 140 may be provided. These points are shown as diamonds in FIG. 3 on the left. Points 140 can be pre-saved or already defined points. Each of the points 140 for the parameters can be based on a curve 130 for the design variable. Each of the points 110 for the parameters can be formed on the basis of one of curves 130.

The y1-y2 diagram with point 145 can be shown on a display device. In addition, points 140 can be shown on the display device.

FIG. 3 on the left also shows a first operating aid 60 and a second operating aid 65 for the parameters. A (separate) operating aid can be provided for each parameter under consideration. When considering (exactly) one parameter, (exactly) one operating aid can be provided for the parameter. When considering n parameters yK, n operating aids can be provided for the parameters.

The first operating aid 60 for the first parameter y1 can include a first selector 61. The second operating aid 65 for the second parameter y2 can include a second selector 66. The position or location of the first selector 61 for the first parameter y1 can represent the value of the first parameter y1. The position or location of the second selector 66 for the second parameter y2 can represent the value of the second parameter y2.

The positions or locations of the first selector 61 for the first parameter y1 and of the second selector 66 for the second parameter y2 can correlate with point 145. The position of point 145 in the y1-y2 diagram and the positions or locations of the first selector 61 for the first parameter y1 and the second selector 66 for the second parameter y2 can be coupled to one another.

The operating aids for the parameters, in particular with the corresponding selector, can be shown on a display device.

FIG. 4 illustrates the role of the user in the procedure.

As shown in FIG. 4 on the left, a Pareto frontier 50 can be provided for the first parameter y1 and the second parameter y2. Pareto frontier 50 does not need to be understood as continuous but instead can be understood as functionally connected. For example, grid points 51, 52, 53, 54, 55, 56 of Pareto frontier 50 are or can be provided.

Each of grid points 51, 52, 53, 54, 55, 56 can represent a Pareto optimum for the two parameters y1, y2.

A deviation can be determined between a point of Pareto frontier 50, such as a grid point 51, 52, 53, 54, 55, 56 of Pareto frontier 50, and point 145 of the two parameters y1, y2. The deviation can be understood as optimization potential,

A user can select one point of Pareto frontier 50. The point can be one or more of grid points 51, 52, 53, 54, 55, 56 of Pareto frontier 50. A user can select multiple points on Pareto frontier 50, such as at different times.

A trajectory 72 (also referred to as a representation of Pareto frontier 50) can be provided for design variable x1. Trajectory 72 for design variable x1 can generally be a representation of Pareto frontier 50 for the two parameters y1, y2. For example, trajectory 72 for design variable x1 can be based on Pareto frontier 50 for parameters y1, y2. Trajectory 72 for design variable x1 can also be formed on the basis of Pareto frontier 50 for parameters y1, y2.

A deviation can be determined between trajectory 72 and curve 135 of design variable x1. This deviation can be understood as an “path towards optimization”. For Pareto optimization of the process, curve 135 of the design variable can be changed according to the deviation.

Points on Pareto frontier 50 for parameters y1, y2 and trajectory 72 for design variable x1 can be linked to one another. For example, if a point on Pareto frontier 50 is selected for parameters y1, y2, a trajectory 72 linked to this point can (also) be selected for design parameter x1. Multiple trajectories 72 can be provided. Each of the trajectories can be linked to a point on Pareto frontier 50 for parameters y1, y2. The point can be selected by the user.

As shown in FIG. 4 on the right, at least one operating aid 71 can be provided for the curve 135 of design variable x1. Operating aid 71 can include at least two, preferably at least three, four or five, selectors 71a, 71b, 71c, 71d, 71e. Operating aid 71 allows the user to adjust curve 135 of the design variable x1. Preferably, at least one of selectors 71a, 71b, 71c, 71d, 71e can be set up or designed to change the position of curve 135. At least one of selectors 71a, 71b, 71c, 71d, 71e can be set up or designed to change the curvature of curve 135. Preferably, at least two selectors 71c, 71e are set up or designed to change the position of curve 135, and at least two selectors 71b, 71d are set up or designed to change the curvature of curve 135.

For example, a user can mark one of selectors 71a, 71b, 71c, 71d, 71e, preferably by touching a touchscreen or by clicking on the selector, and change the position of selector 71a, 71b, 71c, 71d, 71e, preferably by dragging it. This is indicated in FIG. 4 by hand symbol 120. This allows the shape of curve 135 to be changed.

In particular, the shape of curve 135 can be modified in such a way that the shape of curve 135 is more similar to the shape of trajectory 72 than before the modification. The shape of curve 135 may be changed in such a way that a deviation between the shape of curve 135 and trajectory 72 is less than before curve 135 is changed. This allows the process to be Pareto-optimized.

The first operating aid 60 for the first parameter y1 can include a first selector 61. In addition to the first selector 61, a representation 62 of Pareto frontier 50 for parameters y1, y2 may be shown on or in the first operating aid 60. Representation 62 of Pareto frontier 50 for parameters y1, y2 can be a marking on the first operating aid 60. Representation 62 may be a representation of a point of Pareto frontier 50 for parameters y1, y2. Preferably, representation 62 is a representation of the selected point of Pareto frontier 50 for parameters y1, y2.

A representation 67 of Pareto frontier 50 for the parameters may be provided on the second operating aid 65 for the second parameter y2. Representation 67 may be provided in addition to the second selector 66. Representation 67 can be a marker. Representation 67 of the second operating aid 65 may be similar or identical to representation 62 of the first operating aid 60.

In general, a representation of the Pareto frontier for the parameters can be provided for each operating aid for a parameter. A first parameter and a second parameter are merely examples.

In general, at least one condition or constraint 90 may be provided-in particular, shown-in each of the diagrams. Condition or constraint 90 may be an equipment, physical, procedural or chemical condition or Constraint 90. Condition or constraint 90 conveys to the user that a change in the process is occurring in an area of condition or constraint 90, which may be undesirable.

A process design that has been defined by changing at least one value of a design variable can be saved in a database.

1. A method, comprising:
providing a value of a first design variable (x1, x2, . . . , xD) for a process;
providing a value of a first parameter (y1, y2, . . . , yK) and a value of a second parameter (y1, y2, . . . , yK), whereby the value of the first parameter and the value of the second parameter (y1, y2, . . . , yK) are formed on a basis of the value of the first design variable (x1, x2, . . . , xD);
providing a Pareto frontier (10) for the first parameter and the second parameter (y1, y2, . . . , yK); and
determining a deviation of the value of the first parameter (y1, y2, . . . , yK) from a point (11, 12, . . . , 16) of the Pareto frontier (10) and/or determining a deviation of the value of the second parameter (y1, y2, . . . , yK) from the point (11, 12, . . . , 16) of the Pareto frontier (10).

2. The method of claim 1, whereby the point (11, 12, . . . , 16) of the Pareto frontier (10) is defined or selected by a user, in particular the point (11, 12, . . . , 16) of the Pareto frontier (10) is defined or selected by a user from at least three, preferably at least five, more preferably at least ten, points (11, 12, . . . , 16) of the Pareto frontier (10).

3. The method of claim 1, whereby a user defines or changes the value of the first design variable (x1, x2, . . . , xD).

4. . . . The method of claim 1, whereby a value for the first design variable (x1, x2, . . . , xD) and a value for a second design variable (x1, x2, . . . , xD) are provided.

5. The method of claim 4, whereby a Pareto frontier (40) for the first design variable and the second design variable (x1, x2, . . . , xD) or a representation of the Pareto frontier for the first design variable and the second design variable (x1, x2, . . . , xD) is provided, in particular whereby the Pareto frontier (40) for the first design variable and the second design variable (x1, x2, . . . , xD) or the representation of the Pareto frontier is based on the Pareto frontier (10) for the first parameter and the second parameter (y1, y2, . . . , yK).

6. The method of claim 5, whereby a deviation of the value of the first design variable (x1, x2, . . . , xD) from a point (41, 42, . . . , 46) of the Pareto frontier (40) for the first design variable and the second design variable (x1, x2, . . . , xD) is determined and/or a deviation of the value of the second design variable (x1, x2, . . . , xD) from the point (41, 42, . . . , 46) of the Pareto frontier (40) for the first design variable and the second design variable (x1, x2, . . . , xD) is determined.

7. The method of claim 6, whereby it is determined whether the deviation of the value of the first design variable (x1, x2, . . . , xD) from the point (41, 42, . . . , 46) of the Pareto frontier (40) for the first design variable and the second design variable (x1, x2, . . . , xD) is reduced by increasing or by decreasing the value of the first design variable (x1, x2, . . . , xD); and/or whereby it is determined whether the deviation of the value of the second design variable (x1, x2, . . . , xD) from the point (41, 42, . . . , 46) of the Pareto frontier (40) for the first design variable and the second design variable (x1, x2, . . . , xD) is reduced by increasing or decreasing the value of the second design variable (x1, x2, . . . , xD).

8. The method of claim 4, whereby a user defines or changes the value for the first design variable (x1, x2, . . . , xD) and/or the value for a second design variable (x1, x2, . . . , xD).

9. The method of claim 1, whereby the value of the first design variable (x1, x2, . . . , xD) is changed, in particular changed in such a way that the deviation of the value of the first parameter and/or the value of the second parameter (y1, y2, . . . , yK) from the point (11, 12, . . . , 16) of the Pareto frontier (10) for the first parameter and the second parameter (y1, y2, . . . , yK) is reduced.

10. The method of claim 4, whereby the value of the first design variable (x1, x2, . . . , xD) is changed in such a way, in particular by a user, that the deviation of the value of the first parameter and/or the value of the second parameter (y1, y2, . . . , yK) from the point (11, 12, . . . , 16) of the Pareto frontier (10) for the first parameter and the second parameter (y1, y2, . . . , yK); and/or whereby the value of the second design variable (x1, x2, . . . , xD) is changed in such a way, in particular by a user, that the deviation of the value of the first parameter and/or the value of the second parameter (y1, y2, . . . , yK) from the point (11, 12, . . . , 16) of the Pareto frontier (10) for the first parameter and the second parameter (y1, y2, . . . , yK) is reduced.

11. A method, comprising:
providing a value of a first design variable (x1, x2, . . . , xD) for a process;
providing a value of a first parameter (y1, y2, . . . , yK) and a value of a second parameter (y1, y2, . . . , yK), value of the first parameter and the value of the second parameter (y1, y2, . . . , yK) are formed on a of the value of the first design variable (x1, x2, . . . , xD);
providing a Pareto frontier (10) for the first parameter and the second parameter (y1, y2, . . . , yK);
showing a first operating aid (30) with a first selector (31) for the value of the first design variable (x1, x2, . . . , xD), whereby a setting or position of the first selector (31) represents the value of the first design variable (x1, x2, . . . , xD);
showing a representation (32) of the Pareto frontier (10) for the first parameter and the second parameter (y1, y2, . . . , yK) on the first operating aid (30); and
moving or changing, through a user, the setting of the first selector (31) of the first operating aid (30) in [[the]] a direction of the representation (32) of the Pareto frontier (10) for the first parameter and the second parameter (y1, y2, . . . , yK).

12. The method of claim 11, whereby a value for a first design variable (x1, x2, . . . , xD)) and a value for a second design variable (x1, x2, . . . , xD) are provided.

13. The method of claim 12, whereby the first operating aid (30) is shown with the first selector (31) for the value of the first design variable (x1, x2, . . . , xD), whereby the position of the first selector (31) represents the value of the first design variable (x1, x2, . . . , xD); and
whereby a second operating aid (35) is shown with a second selector (36) for the value of the second design variable (x1, x2, . . . , xD), whereby the setting or position of the second selector (36) represents the value of the second design variable (x1, x2, . . . , . . . , xD), and whereby one representation (32, 37) of the Pareto frontier (10) for the first parameter and the second parameter (y1, y2, . . . , yK) is shown on the first operating aid and the second operating aid (30, 35), respectively.

14. The method of claim 13, whereby the user moves or changes the setting of the first selector and/or the second selector (31, 36) in the direction of the representation (32, 37) of the Pareto frontier (10) for the first parameter and the second parameter (y1, y2, . . . , yK).

15. The method of claim 13, whereby the setting of the first selector and/or the second selector (31, 36) are moved or changed in the direction of the representation of the Pareto frontier (10) for the first parameter and the second parameter (y1, y2, . . . , yK) by an input of the user.

16. The method of claim 11, whereby a first operating aid (20) is shown with a first selector (21) for the value of the first parameter (y1, y2, . . . , yK), whereby a setting or position of the first selector (21) represents the value of the first parameter (y1, y2, . . . , yK); and whereby a second operating aid (25) is shown with a second selector (26) for the value of the second parameter (y1, y2, . . . , yK), whereby a setting or position of the second selector (26) represents the value of the second parameter (y1, y2, . . . , yK).

17. The method of claim 16, whereby one representation (22, 27) each of the Pareto frontier (10) for the first parameter and the second parameter (y1, y2, . . . , yK) is shown on the first operating aid (20, 25) for the value of the first parameter (y1, y2, . . . , yK) and on the second operating aid (20, 25) for the value of the second parameter (y1, y2, . . . , yK).

18. The method of claim 17, whereby the user moves or changes the setting of the first selector and/or the second selector (21, 26) in the direction of the representation (22, 27) of the Pareto frontier (10) for the first parameter and the second parameter (y1, y2, . . . , yK).

19-27. (canceled)

28. A method, comprising:
providing values of a design variable (x1, . . . , xD) for a process, whereby at least two of the values differ from one another as a function of time;
providing a value of a first parameter (y1, y2, . . . , yK) and a value of a second parameter (y1, y2, . . . , yK), whereby the values of the first parameter and the second parameter (y1, y2, . . . , yK) are formed on a of the values of the first parameter (x1, x2, . . . , xD);
providing a Pareto frontier (50) for the first parameter and the second parameter (y1, y2, . . . , yK); and
determining a deviation of the value of the first parameter (y1, y2, . . . , yK) from the Pareto frontier (50) and/or determining a deviation of the value of the second parameter (y1, y2, . . . , yK) from the Pareto frontier (50).

29. The method of claim 28, further comprising:
determining a deviation of the value of the first parameter (y1, y2, . . . , yK) from a point (51, 52, . . . , 56) of the Pareto frontier (50) and/or determining a deviation of the value of the second parameter (y1, y2, . . . , yK) from the point (51, 52, . . . , 56) of the Pareto frontier (50).

30. The method of claim 28, whereby a user defines or changes at least one of the values of the design variable (x1, . . . , xD).

31. The method of claim 28, whereby a trajectory (72) for the design variable (x1, . . . , xD) is determined on a basis of the Pareto frontier (50) for the first parameter and the second parameter (y1, y2, . . . , yK), in particular whereby values of at least two points on the trajectory (72) are different from one another as a function of time.

32. The method of claim 28, whereby a curvature of a curve is changed by the values of the design variable (x1, . . . , xD), in particular changed by a user.

33. A method, comprising:
providing values of a design variable (x1, . . . , xD) for a process;
providing a value of a first parameter (y1, y2, . . . , yK) and a value of a second parameter (y1, y2, . . . , yK), whereby the values of the first parameter and the second parameter (y1, y2, . . . , yK) are formed on a of the values of the design variable;
providing a Pareto frontier (50) for the first parameter and the second parameter (y1, y2, . . . , yK);
showing an operating aid (71) with a plurality of selectors (71a, 71b, . . . , 71e) for the values of the design variable (x1, . . . , xD), whereby a setting or position of the plurality of selectors (71a, 71b, . . . , 71e) define or reflect the values of the design variable (x1, . . . , xD);
showing a representation (72) of the Pareto frontier (50) for the first parameter and the second parameter (y1, y2, . . . , yK); and
moving or changing, through a user, the position of at least one of the plurality of selectors (71a, 71b, . . . , 71e) of the operating aid (71).

34. The method of claim 33, whereby by moving or changing the setting of at least one of the plurality of selectors (71a, 71b, . . . , 71e), a curvature of a curve is changed by the values of the design variable (x1, . . . , xD).

35. The method of claim 33, whereby the operating aid (71) includes at least three, preferably at least four, more preferably at least five, selectors (71a, 71b, . . . , 71e).

36-61. (canceled)
